(19) United States
(12) Patent Application Publication
(10) Pub. No.: US 2007/0024895 A1
(43) Pub. Date: Feb. 1, 2007

(54) Push forward print tasking in a computer network

(76) Inventor: Gordon R. Clark, Meridian, ID (US)

Correspondence Address: AVAGO TECHNOLOGIES, LTD., P.O. BOX 1920, DENVER, CO, 80201-1920, US

(21) Appl. No.: 11/191,357

(22) Filed: Jul. 28, 2005

(51) Int. Cl. G06F 3/12

(52) U.S. Cl. 358/1.15

(57) ABSTRACT

In a network system having a plurality of computers and a plurality of commonly accessible printers, at least two printers are enabled to selectively forward at least a portion of a print task to an alternative printer. The forwarding is an automated response to a comparison of current print capabilities of the forwarding-enabled printer to requirements of the specific print task. Each forwarding-enabled printer is “environmentally aware” with respect to other commonly accessible printers of the network. The awareness may be with respect to the physical locations, the inherent capabilities, and/or the current resource availabilities of the other printers.

### BACKGROUND ART

In a computer environment, computers are interconnected to enable the exchange of data. For example, the network may be a local area network (LAN) of a particular business. There are a number of known topologies for networks, including star networks that include a centralized control and bus networks that link the various network components via a network bus.

In addition to the various computers, network components include printers that are commonly accessible. That is, rather than a standalone printer that is dedicated to a particular user, a network may support a series of printers having greater sophistication than the standard standalone printer. For each network computer, its user may select a default printer, but has the option of selecting an alternative network printer for a particular print task.

For various reasons, a print task sent to a printer may be aborted or prematurely terminated. Printer resources, such as paper or toner, may be exhausted or the printer may jam or otherwise malfunction. In these situations, the user must resubmit the print task to a printer having the capability of executing the print task or must correct the situation at the originally designated printer. Inefficiencies within the network may also arise when the designated printer has multiple print tasks waiting in the print queue. If a user is aware of the backlog of tasks in the queue, another printer may be manually selected. However, information regarding the various queues may not be available at the computer of the user.

U.S. Pat. No. 6,529,286 to King describes a dynamically distributed shared printer interface (DDSPI) to which all print tasks of a computer network are routed. The DDSPI then routes the print tasks to printers in a user-defined preferred printer list (PPL) based upon a printer's capability to print a certain job. The DDSPI calculates the estimated workload to print the task and transmits a multi-cast to the printers in the PPL, requesting printer capability information. The information may include the printer engine speed, printer memory size, and the number, size and complexity of print tasks waiting in the printer queue. The DDSPI routes the print tasks to a particular printer on the basis of the information. As another aspect of the King invention, the DDSPI may re-route a print task if the originally selected printer develops an error, with the DDSPI resending a multi-cast to the remaining printers in order to reacquire the information needed for printer selection.

Another patent of interest is U.S. Pat. No. 6,552,813 to Yacoub, which describes a “virtual printer.” The virtual printer checks the preferences of a user regarding a print task. The preferences include speed and image quality. Next, the virtual printer determines, using a server, database or other query, the most appropriate network printer to actually execute the printing. The appropriateness is based upon the preferences and the physical location of the printer. If the selected printer returns an error signal, the virtual printer determines a different printer which closely complies with the preferences. On the other hand, if a busy signal is returned rather than the error message, the user is given a choice of waiting or commanding the virtual printer to automatically determine the next available appropriate printer. When the print task is complete, the user is notified of the physical location of the printer at which the task was processed.

The centralized printer selections of King and Yacoub offer advantages relative to conventional approaches to processing print tasks. Additional network components are necessary, but the interaction by a user is reduced in some situations.

### SUMMARY OF THE INVENTION

In accordance with the invention, a network system that supports communications among various computers includes forwarding-enabled printers that are configured to selectively forward at least a portion of a print task to another network printer as an automated response to a comparison of current print capabilities of the forwarding-enabled printer to requirements of the print task. Each forwarding-enabled printer is able to determine its current print capabilities and to exchange data among the other network printers, so as to monitor considerations significant to decisions of whether to forward a particular print task. Each forwarding-enabled printer may be considered to be environmentally aware. That is, considerations such as the physical locations of the other printers and the availabilities of the printer resources (e.g., paper and toner) may be accessed and utilized in printer selections, if forwarding is at issue for a particular print task.

In a method embodiment of the invention, the forwarding-enabled printer receives a specific print task and determines whether the task should be initiated at the printer. If the printer is the default printer of a user, there is a bias toward initiating the print task at the printer. In response to an affirmative determination to initiate the print task, printing is started. However, in response to a negative determination, an alternative printer is selected on the basis of information relevant to capabilities of the other printers to execute the print task.

If the specific print task is started at the receiving forwarding-enabled printer, but the task cannot be completed, only the remaining portion of the task is forwarded to an alternative printer. A display of the first printer may be used to present human-readable information as to the location of the end portion of the print task. Similarly, if the entire task has been forwarded to an alternative printer, the display at the first printer may be used to inform the user of the actual location.

The division of a print task among different printers may be based upon considerations other than encountering a difficulty after the task has been initiated. As one possibility, a print task may be divided among printers in order to increase efficiency. For example, the receiving printer may automatically divide a lengthy print task or may divide a print task in which the requirements vary among the pages, such as a document having both text-only pages and photo-quality pages. As another example, a print task which requires multiple copies may be divided among multiple printers so that the copies are printed in parallel. Such load balancing and load sharing is performed “intelligently.”

The forwarding-enabled printer may include sensors for monitoring resource availabilities. Toner supply sensors are well known in the art. Currently, it is also possible to install sensors that monitor the quantity of paper within a paper supply, so that the availability of paper is known before the supply is exhausted. Less important resources may also be monitored, such as the supply of staples for a printer having automatic stapling capability.

The operations of the forwarding-enabled printer may be implemented in hardware, software, firmware, or a combination of the three. Thus, a “processor” may include a task requirement identifying module, a resource monitor module, a comparator, a task controller module, a task forwarding module, and an external printer environment monitor module. The comparator is used to determine whether the requirements of a particular print task may be satisfied by that printer or by another printer, given the current capabilities of the printer or printers. The task controller includes a printer formatter. The external printer environment monitor can include a management information base (MIB) of the information regarding the other printers. As another feature of the invention, there may be an “override” that allows a user to disable the forwarding capability of a printer for a particular print task.

### BRIEF DESCRIPTION OF THE DRAWINGS

FIG. 1 is a schematic view of a network environment for implementation of the present invention.

FIG. 2 is a block diagram of a forwarding-enabled printer in accordance with an exemplary embodiment.

FIGS. 3, 4 and 5 show one possible flow of steps for processing a print task in accordance with the invention.

### DETAILED DESCRIPTION

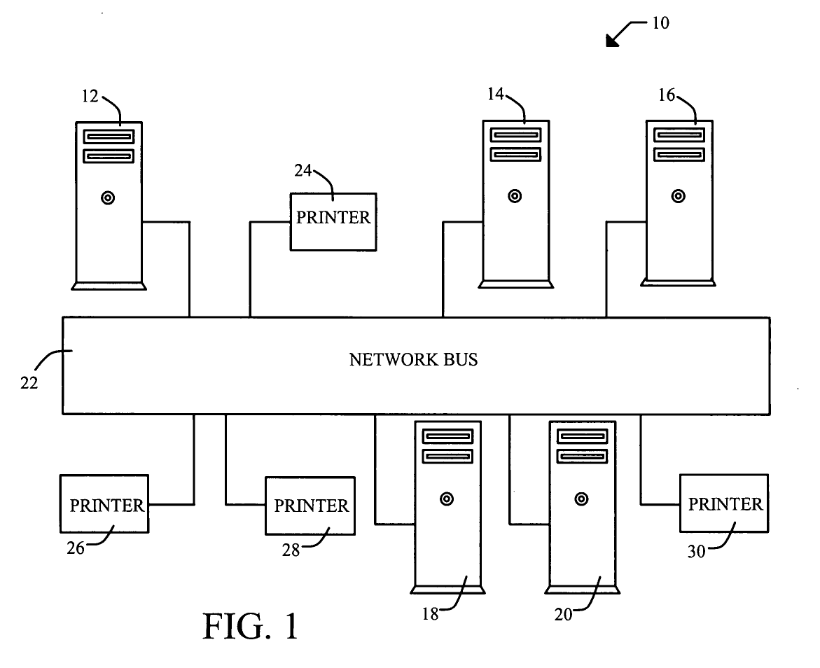

With reference to FIG. 1, a simplification of a data exchange network 10 is shown as including five computers 12, 14, 16, 18 and 20 that are connected to a network bus 22 to allow data communications among the computers. As one possibility, the network may be a packet switching LAN of a privately owned business. Typically, there are significantly more computers and there is a wider range of network components. A shared file-storage device, such as a file server, may be accessible to the various computers. A communications server may provide access to the Internet.

While the network 10 is shown as being a bus network, the invention may be used in other topologies. Merely to state a second possibility, the computers 12-20 may each be connected to a centralized controller to form a star network topology. The network protocol is not a significant factor in the implementation of push forward print tasking to be described below. The network may be wired or may be wireless.

In addition to the computers 12-20, the network 10 is shown as including four printers 24, 26, 28 and 30. In the illustrated embodiment, each printer is connected to the network bus 22. Alternatively, the push forward print task may be through a printer server. That is, a printer server may be connected to the network bus in order to support the various printers. Then, a print task submitted by one of the computers is received at the printer server for direction to the target printer. In another alternative embodiment, one or more of the computers may be directly connected to a standalone printer that is not shared by the other computers of the network.

At least two of the printers 24-30 are forwarding-enabled printers which are “environmentally aware.” That is, each forwarding-enabled printer has access to information regarding other printers of the network, wherein the information is relevant to forwarding a received print task to an alternative printer. The relevant information may include all or a subset of the physical locations of the other printers, the capabilities of the other printers (such as color capability or automatic stapling capability), the current availability of print resources (such as paper, toner and staples), and the current status of the other printers (such as information regarding a paper jam or other printer malfunction and/or information regarding a possible backlog of print tasks in a print queue). Having access to such information, each forwarding-enabled printer is able to make informed decisions as to re-routing a print task originally received at that printer.

The invention provides different aspects to enhancing the “intelligence” of a printer. This additional intelligence has much to do with the awareness of the environment in which the printer is placed. The environmental awareness may be acquired by the printer on its own or may be acquired at an initial setup process. At the top of the environment awareness is the information regarding the immediately surrounding printers, if any. Neighboring printers can be fit into common sets of functionality and can be classified within a management information base (MIB) of the printer. In this fashion, a forwarding-enabled printer can utilize the capabilities of other printers as desired or as directed.

Even if a forwarding-enabled printer is the only printer in a small office environment, the printer may be more diligent about reporting its resource needs or errors to a user as a preventative measure. This is a possibility because the print solution comprehends the limited available resources and is cognizant of the use requirements placed upon the printer. This cognizance of use requirements may be “predictive,” since the printer solution may include programming for examining the history of past usage of the printer and for applying a probability factor as to the likelihood that the same pattern of usage will occur in the near future.

One role of the application is to increase the number of options available to a user. The invention can combine the print resources in a given network environment into a comprehensive print solution. The ease of use is enhanced by providing fault tolerances, added capabilities, and proactive feedback to the user. The print solution simplifies administration by treating the solution as a whole, instead of as individual print resources in which each resource requires separate and different administration. Moreover, the invention allows a solution in which print tasks can be routed depending on the present status or capabilities of various printers. The user may direct this routing at the driver level or at the printer level itself. Furthermore, the routing may be proactively suggested to the user by the print solution.

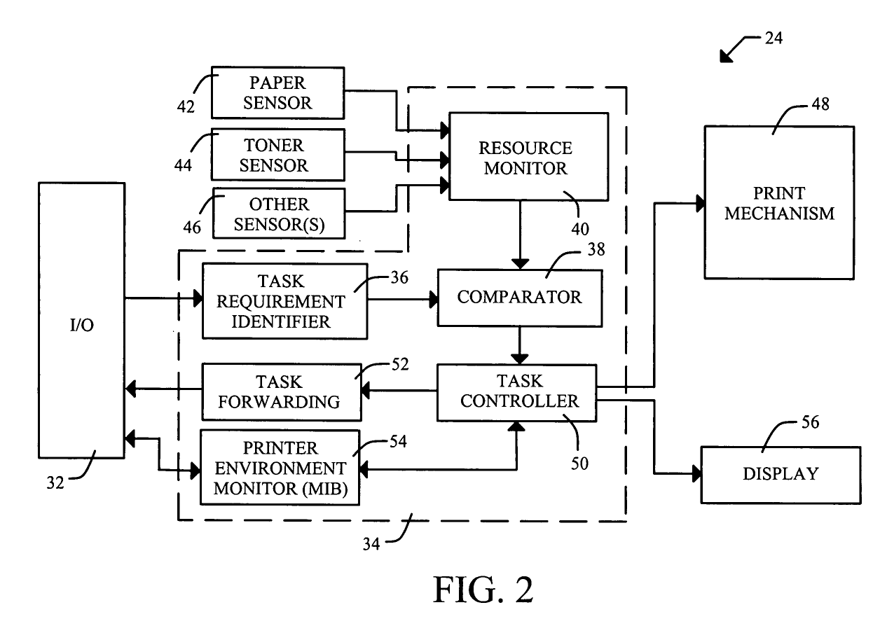

Referring now to FIG. 2, a forwarding-enabled printer 24 is shown as including an input/output (I/O) capability 32. The I/O allows the printer to communicate with other network components, including at least one computer and at least one other printer. The I/O may include a conventional port for connection to a cable or may include components for enabling wireless communication. Providing the input/output capability is well within level of skill in the art.

The forwarding-enabled printer 24 includes a “processor” 34 that may be implemented in a combination of hardware, software and firmware. The processor includes a task requirement identifier 36 connected to the I/O 32. Upon receiving a print task, the identifier 36 determines requirements in processing the task. As one example, if a print task has been submitted to the printer 24 by a computer, the identifier may determine whether the processing requires photo capability and/or the availability of a large supply of paper. Such information may be contained in a header that identifies the attributes of a received print task. However, there may be other automated techniques for determining requirements necessary to print a job submitted by a computer.

The “processor” 34 also includes a comparator 38 that receives an input from the task requirement identifier 36 and an input from a resource monitor 40. The resource monitor includes information specific to the capabilities of the printer, such as resolution limitations imposed by the design of the printer. In addition, the resource monitor is connected to one or more identifiers of “dynamic limitations.” In the embodiment of FIG. 2, the resource monitor is connected to a paper sensor 42. In its simplest form, the paper sensor merely identifies a paper-out status when the supply of paper has been exhausted. However, in a more sophisticated embodiment, the paper sensor is able to provide at least an estimate of the number of sheets of paper remaining within the supply tray. Techniques for providing such an estimate are within the level of skill in the art. As used with respect to the sensor 42, the term “paper” should be interpreted broadly to include transparencies and other print media used in conventional printers.

A second sensor is the toner sensor 44. If it is determined that a supply of toner has been exhausted or is near exhaustion, a signal is sent to the resource monitor 40 to communicate this information, so as to allow informed decisions as to the ability of the printer 24 to complete a print task. The term “toner” should be interpreted broadly to include inks and other print materials used in printers. Signals may also be submitted from other sensors 46, such as a sensor which determines whether there are staples available for an automatic stapling capability. Any one of the various sensor 42, 44 and 46 may be optical, mechanical or a combination thereof.

At the comparator 38, the “processor” 34 determines whether there is a compatibility between the task requirements identified at the identifier 36 and the current capabilities identified by means of the resource monitor 40. Typically, the print task has been directed to the printer 24 as a result of a selection by a user. For example, the printer may be the default printer of the user's computer. Thus, there is a preprogrammed bias toward using the print mechanism 48 of the printer to complete the task. However, there will be occasions in which the completion is not an option without further involvement by the user. For example, if the supply of paper is insufficient, the user will need to add paper if the printer 24 is to complete the task. Moreover, the printer 24 may not have the capability, such as when a print task includes a color photograph and the printer is not designed for color capability.

The output of the comparator 38 is forwarded to a task controller 50. The task controller cooperates with the comparator in determining whether the print mechanism 48 is to be used or whether a task is to be forwarded to an alternative printer.

If it is determined at the task controller 50 that the particular print task is to be processed locally, the print mechanism 48 is utilized. The mechanism may use any of the known techniques. For example, inkjet printing or laser printing may be employed. If the task is started at the print mechanism but cannot be completed as a result of a paper jam or other reason, the task controller remains active, so as to allow redirection for completion of the task by a second printer. The “processor” 34 of the printer 24 includes a task forwarding module 52 for submitting at least a portion of a print task to the second printer via the I/O capability 32.

As previously noted, the forwarding-enabled printer 24 is “environmentally aware.” A printer environment monitor 54 enables the printer 24 to access information relative to capabilities of other network printers. If each forwarding-enabled printer within a network includes the same suite of software, standard techniques of signal exchanges may be utilized for printer-to-printer communications. Each such printer may send out queries intended to determine inherent capabilities of the printers, such as color, resolution, paper type and size, and automatic stapling capabilities. As a second category of exchanged information, the printer environment monitor 54 acquires information regarding the “dynamic capabilities” of the other printers. Thus, if a second printer is unavailable as a result of a malfunction or a significant backlog in print tasks, this information is available to the printer 24. A third category is specific to the physical location of the other printers. If the second printer is next to the printer 24, it is more reasonable to forward the print task to the second printer, rather than a more distant third printer. In a wireless environment, physical location may be determined using an algorithm which considers the time required to return a “ping” to/from the other printer(s). However, there may be other approaches, such as the manual input of a number which is interpreted by the printer 24 as the designation of distance to the associated other printer. In a simple form, input of a “0” may indicate that the printer associated with the input is immediately adjacent to the printer 24, while input of “10” may indicate that the other printer is far removed from the printer 24.

The final component shown in FIG. 2 is a display 56. If a print-task is forwarded to another printer, the location of the printer may be identified to the user viewing the display 56. In the alternative, the notification of the actual location of printing may be sent to the computer from which the print task was originally submitted.

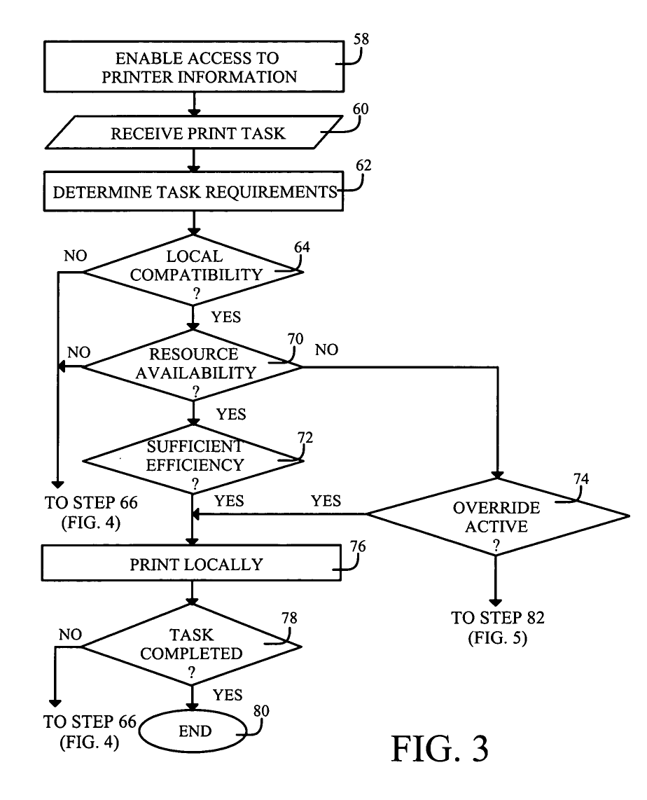

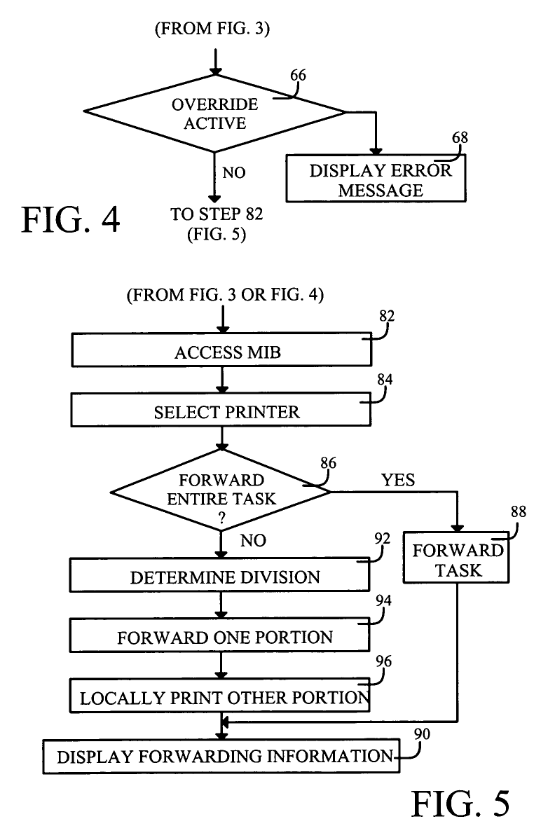

FIGS. 3-5 illustrate a process flow of steps for utilizing the features of the forwarding-enabled printer of FIGS. 1 and 2. However, the process is merely one embodiment, since persons skilled in the art will recognize that modifications are available without diverging from the invention. At step 58, access to information regarding the printer environment is enabled. That is, “environmental awareness” is enabled. As previously noted, this knowledge regarding the environment in which the printer resides may be acquired by the printer itself or may be input during an initial setup procedure. At the top of the environmental awareness is the knowledge regarding the surrounding printers and their individual resources. Neighboring print resources can be fit into common sets of functionalities and may be classified within the management information base (MIB) 54 of FIG. 2.

A print task is received via the I/O capability 32, as indicated at step 60. The reception may be a result of the printer being designated as the default printer at the user's computer from which the print task is submitted. Alternatively, the user may have manually selected the printer for the specific task.

In step 62, the requirements for the print task are determined. In FIG. 2, this may be done by the task requirement identifier 36, which acquires the information from analysis of a header or the content of the signals received from the user's computer.

Decision step 64 determines whether the printer is compatible with the task requirements. Thus, if the print task requires color capability and the printer is not designed for such capability, a negative response occurs at decision step 64. The negative response causes the process to progress to decision step 66 of FIG. 4. Here, it is determined whether the user has disabled the forwarding capability. This “forwarding override” is an added feature of the invention and may not be used in all embodiments. At step 66, an indication that the forwarding override is active may result in the display of an error message, as shown at step 68. The error message may be presented to the user using either or both of the display 56 of FIG. 2 or the computer from which the print task was originally submitted.

Returning to the decision step 64 in FIG. 3, if an affirmative response is generated, the resource availability is determined at decision step 70. Using the paper sensor 42, the toner sensor 44, and the other sensor(s) 46, the current availability of resources is compared with the requirements for processing the print task. If the task specifies a particular resource that is either exhausted or insufficiently available, the result is the same as receiving the negative result at step 64. That is, the process determines whether the forwarding override feature has been activated at step 62 of FIG. 4. With the override activated, an error message is displayed at step 68.

With affirmative responses to the decision steps 64 and 70 of FIG. 4, the issue at step 72 relates to efficiency in processing the print task. Thus, for networks in which there is more than one printer, there may be a way to load balance the print tasks among the printers, thereby reducing potential delays. A decision to load balance may be based upon the length of a print task or upon other considerations, such as forwarding pages requiring color and locally printing pages that do not require the time necessary to print a color page. The decision may also be based on the number of copies specified in a print task. If multiple copies are required, the workload may be shared by dividing the number of copies among printers. If it is determined that efficiency can be improved (a negative response at step 72), the process checks to determine whether the override has been activated, as indicated at step 74. The override check is identical to that described with reference to FIG. 4, if the override is active. Specifically, the task-forwarding process of FIG. 5 is triggered, as will be described below. On the other hand, an affirmative response at step 74 does not result in display of an error message. Instead, the result is the same as if an affirmative response were detected at step 72. That is, the printing starts “locally” (step 76) at the printer originally receiving the print task.

Thus, affirmative responses at steps 64 and 70 along with an affirmative response at either step 72 or 74, result in the printing process being started locally. If the entire document is printed, the process will end (step 80). However, a printing-incomplete status will be detected at decision step 78, if the printing process is prematurely terminated for reasons such as a paper jam or other malfunction. If the print task is not completed, the forwarding-enabled printer determines at step 66 of FIG. 4 whether the forwarding-override feature has been activated by a user to prevent forwarding of the particular print task to another printer. If the override feature is active, an error message is displayed at the local printer (step 68). For situations in which the override feature has not been activated, the task-forwarding procedure of FIG. 5 begins. Similarly, a negative response at step 74 of FIG. 3 triggers the task-forwarding procedure.

Referring now to FIGS. 2 and 5, if the task-forwarding procedure has been triggered, the management information base (MIB) of the printer environment monitor 54 is accessed. The information within the MIB is used to select an alternative printer to which the print task is forwarded. The information may be “pushed” to the local printer. That is, other forwarding-enabled printers may be programmed to automatically send any status changes to the other forwarding-enabled printers. Alternatively, each such printer may send queries to the other printers in order to acquire the information for environmental awareness. The access MIB step 82 of FIG. 5 may include the automatic querying of other printers in order to update the information. For example, there may be a query requesting information regarding the available sheets of paper within a supply tray of the other printer or printers.

Based upon the information within the MIB, an alternative printer is selected at step 84. The selection may be exclusively internal to the printer. As previously noted, at the top of the environmental awareness is the information relating to the printers that are in the same physical location as the forwarding printer. The information regarding the capabilities and the current resource availabilities for the neighboring printers is of primary significance. On the other hand, the printer may route suggestions as to re-routing to the computer of the user, so that the user is able to proactively determine the printer to which the print task is forwarded.

The next step 86 hinges upon whether the entire print task or only a portion of the print task is to be forwarded. For those situations in which the task is to be forwarded in its entirety, step 88 represents the transmission of the print task to the selected printer. Then, the display 56 of the printer 24 is used to present the forwarding information. Simultaneously or alternatively, the forwarding information is sent to the user's computer.

A negative response at step 86 results in load sharing. There are a number of possible reasons to utilize load sharing. Referring to FIG. 3, if at step 64 it is determined that the local computer does not have the capability of printing all pages of a document, the portion for which there is compatibility may be printed locally, while the other portion may be forwarded to a printer having the necessary capabilities. This may occur if a multi-page document includes a number of text-only pages and a single photograph. The decision to forward only a portion of a document may also be a result of a negative response at step 70 of FIG. 3. If there is sufficient resource availability (e.g., paper) to print only a subset of the pages of a document, the print task may be divided. Load sharing may also be a result of the determination that efficiency can be increased. At decision step 72, the efficiency concerns may determine that it is efficient to divide a document on the basis of factors such as length, number of copies, and page-to-page differences in print requirements (e.g., text as compared to photographs). Load sharing may also be based upon the determination at step 78 that while the print process was started locally, it could not be completed. In such a situation, the remainder of the task may be forwarded to the alternative printer.

In step 92, the specifics of the division of the print task are determined. The criteria for the division will depend upon the reason for dividing the print task. In step 94, one portion of the print task is forwarded to the printer selected at step 84. In some situations, the load sharing may be among more than two printers, so that multiple printers are selected at step 84. The remaining portion of the print task is locally printed, as indicated at step 96. Information regarding the forwarding is displayed to the user at step 90. Again, the presenting of the information to the user may use one or both of the display 56 of the printer 24 of FIG. 2 and the computer system of the user.

While the process flow described with reference to FIGS. 3, 4 and 5 is one possible implementation of the invention, persons skilled in the art will recognize that modifications may be made to the process without diverging from the invention.

What is claimed is:

1. A network system comprising:
a plurality of computers connected to form a network; and
a plurality of printers connected to said network to enable execution of print tasks forwarded from said computers, wherein at least two of said printers are forwarding-enabled printers that include a processor configured to selectively forward at least a portion of a specific said print task to an alternative one of said printers as an automated response to a comparison of current print capabilities of said forwarding-enabled printer to requirements of said print task.

2. The network system of claim 1 wherein said processor of each said forwarding-enabled printer is configured to monitor each said printer.

3. The network system of claim 2 wherein each said forwarding-enabled printer includes an input/output cooperative with said processor to enable exchanges of data among said printers, including data specific to print capabilities of said printers.

4. The network system of claim 1 wherein each said forwarding-enabled printer includes a paper sensor positioned to detect a current availability of paper, said processor of each said forwarding-enabled printer including a comparator to determine whether said current availability is sufficient for execution of said specific print task.

5. The network system of claim 1 wherein said processor of each said forwarding-enabled printer includes a task controller module configured to initiate forwarding of an end portion of said specific print task upon detection of an inability to complete said end portion, such that said specific print task has front and end portions printed by different said printers.

6. The network system of claim 1 wherein each said forwarding-enabled printer includes a display that is responsive to said processor to identify said alternative printer to which said specific print task was forwarded.

7. The network system of claim 1 wherein said processor is configured to divide said specific print task into first and second portions and to forward said second portion to said alternative printer, said processor basing said dividing upon timing considerations in completing said specific print task.

8. The network system of claim 1 wherein said processor is configured to divide said specific print task into first and second portions and to forward said second portion to said alternative printer, said processor basing said dividing upon different printing capabilities of said printers.

9. The network system of claim 1 wherein said computers include computer-executable code for selectively disabling print task forwarding capability by said forwarding-enabled printers.

10. A method of processing print tasks within a network that includes a plurality of printers, including a first printer having print capability, said method comprising:
enabling said first printer to access information regarding other said printers, including information relevant to capabilities to execute said print tasks;
receiving a specific print task at said first printer;
determining at said first printer whether to initiate said print task;
in response to an affirmative determination to initiate said print task at said first printer, starting printing at said first printer; and
in response to a negative determination to initiate said print task at said first printer, forwarding said print task to an alternative printer of said network, including selecting said alternative printer on a basis of said information regarding said other printers.

11. The method of claim 10 wherein enabling said first printer to access said information includes initializing programming within said printers for exchanging signals containing said information, said information including print capabilities of each said printer.

12. The method of claim 11 wherein initializing said programming includes enabling storage of information specific to physical locations of said printers, said storage being at each said printer.

13. The method of claim 10 further comprising detecting when said print task cannot be completed at said first printer after starting said printing at said first printer, said detecting occurring at said first printer and triggering a forwarding of an uncompleted portion of said print task to a second printer.

14. The method of claim 13 further comprising presenting a human-readable display identifying printers involved in printing said print task.

15. The method of claim 10 further comprising determining whether to divide said print task received at said first printer such that different portions of said print task are processed at different printers, including basing division of said print task on said information regarding said other printers.

16. The method of claim 10 wherein determining whether to initiate said print task includes comparing requirements of completion of said print task to a supply of available but limited print resources.

17. A printer comprising:
an input/output enabled for communication with a computer and with at least one other printer;
a task requirement module for determining requirements of a print task received from said computer via said input/output;
a comparator module for comparing resources currently available at said printer to said requirements determined by said task requirement module;
a task controller for selecting between processing of said print task at said printer and forwarding said print task to a second said printer, said task controller being responsive to an output of said comparator module;
a print mechanism for executing said print task in response to said selecting by said task controller;
a printer environment monitor connected to said input/output for accessing information specific to capabilities of each said other printer; and
a task forwarding module responsive to said task controller and said printer environment monitor for selectively forwarding said print task to a particular said other printer.

18. The printer of claim 17 further comprising a display operatively associated with said task controller to present information indicative of processing of said print task, including printer location.

19. The printer of claim 17 wherein said task controller is configured to divide said print task in response to said information specific to said capabilities of each said other printer.

20. The printer of claim 17 wherein said comparator module has inputs from a paper supply detector for monitoring the level of available paper for executing print tasks.
